(19) United States
(12) Patent Application Publication
(10) Pub. No.: US 2004/0112410 A1
(43) Pub. Date: Jun. 17, 2004

(54) Substrate treating apparatus and substrate treating method

(75) Inventors: Hiroyuki Araki, Kyoto (JP); Ryotaro Ogushi, Kyoto (JP); Shuzo Nagami, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/730,465

(22) Filed: Dec. 8, 2003

(30) Foreign Application Priority Data
Dec. 11, 2002 (JP) 2002-359357

(51) Int. Cl. B08B 3/04

(52) U.S. Cl. 134/26; 134/36; 134/56 D; 134/95.1; 134/186; 134/902

(57) ABSTRACT

A substrate treating apparatus and substrate treating method for performing at least cleaning treatment of substrates. The substrate are cleaned in a treating tank while a cleaning liquid (deionized water) is introduced into the treating tank through a bottom thereof and an excess amount of the cleaning liquid is allowed to overflow the tank. During the treatment, a feeding flow rate of the cleaning liquid is varied with time, to prevent a stagnation of flows in the tank and promote the effect of removing particles. The cleaning liquid in the tank is not drawn off quickly, to avoid unnecessary vibration being applied to the substrates.

### BACKGROUND OF THE INVENTION

(1) Field of the Invention

This invention relates to a substrate treating apparatus and substrate treating method for cleaning semiconductor wafers, glass substrates for photomasks, glass substrates for liquid crystal displays, substrates for optical disks and so on (hereinafter simply called “substrates”) by immersing the substrates in a cleaning liquid stored in a treating tank.

(2) Description of the Related Art

Conventional substrate treating apparatus for performing cleaning treatment (usually with deionized water) after a chemical treatment of substrates are classified into the following two types.

The first type continuously supplies deionized water at a constant flow rate to the bottom of a treating tank with substrates placed therein. An excess amount of deionized water is allowed to overflow the top of the treating tank. This is called an “overflow rinse type” substrate treating apparatus (see, for example, Japanese Unexamined Patent Publication No. 2002-289574, page 4, paragraph “0019” and FIG. 1).

In the second type of apparatus, deionized water is showered from above a treating tank over substrates placed in the treating tank while deionized water is supplied at a constant flow rate to the bottom of the tank. Then, while supplying only the shower, the cleaning liquid in the tank is drained quickly from the bottom of the tank. The above procedure is repeated thereafter to clean the substrates. This is called a “quick drain shower type” substrate treating apparatus.

The conventional substrate treating apparatus noted above have the following drawbacks.

The “overflow rinse type” substrate treating apparatus continuously supplies deionized water at a constant flow rate into the treating tank. Thus, there constantly exist portions of the water flowing relatively quickly and portions flowing slowly (or stagnant portions) in the treating tank. Particles washed away from substrate surfaces tend to collect in the stagnant portions, and are not easily removed from the treating tank. Consequently, the particles remaining in the treating tank could re-adhere to and contaminate the substrates.

The “quick drain shower type” substrate treating apparatus temporarily empties the treating tank of the cleaning liquid in a quick drain cycle. Thus, unlike the “overflow rinse type”, this apparatus does not allow the particles to remain in the treating tank. However, rapid flows of the cleaning liquid in time of quick drain vibrate the substrates in the treating tank to rub the substrates against guide members supporting the substrates. This gives rise to a different problem of producing particles to contaminate the substrates.

### SUMMARY OF THE INVENTION

This invention has been made having regard to the state of the art noted above, and its object is to provide a substrate treating apparatus and substrate treating method for eliminating the possibilities of particles remaining in a treating tank and of applying unnecessary vibration to substrates in time of cleaning treatment.

The above object is fulfilled, according to this invention, by a substrate treating apparatus for performing cleaning treatment of substrates, comprising a treating tank for receiving a cleaning liquid introduced through a bottom thereof, and allowing an excess amount of the cleaning liquid to overflow a top thereof, a cleaning liquid supply device for supplying the cleaning liquid to the treating tank, and a flow control device for varying with time a feeding flow rate of the cleaning liquid from the cleaning liquid supply device during the cleaning treatment of the substrates placed in the treating tank.

According to this invention, during a process of cleaning the substrates placed in the treating tank, there occur variations with time in the feeding flow rate of the cleaning liquid. This varies the flows of and agitates the cleaning liquid inside the treating tank to eliminate the possibility of stagnations occurring constantly. Particles detaching from the substrates overflow the tank to be drained with excess parts of the cleaning liquid, instead of remaining in the tank. Consequently, the substrates are never contaminated by particles remaining in the treating tank. The cleaning liquid is not quickly drawn off during the substrate cleaning treatment as is the case with a conventional “quick drain shower type” substrate treating apparatus. The substrates are not subjected to unnecessary vibration, and thus no chance of particles resulting from vibration of the substrates.

Preferably, the flow control device is arranged to repeat a supplying step for supplying the cleaning liquid, and a suspending step for suspending supply of the cleaning liquid. With this construction for repeating the supplying step for supplying the cleaning liquid, and the suspending step for suspending supply of the cleaning liquid, there is no possibility of stagnations occurring constantly inside the treating tank. Particles detaching from the substrates overflow the tank to be drained with excess parts of the cleaning liquid.

A period of time for suspending the supply of the cleaning liquid is set appropriately. Preferably, the supply is stopped for five to 30 seconds. An insufficient supply suspension period would lower the effect of agitating the cleaning liquid. An overlong suspension period would lower cleaning efficiency (throughput).

Preferably, a longer time is set for supplying the cleaning liquid in the supplying step executed first than in the supplying step executed subsequently, in order to replace a chemical solution in the treating tank with the cleaning liquid.

It is also preferred that the flow control device is arranged to repeat a first supplying step for supplying the cleaning liquid at a first flow rate, and a second supplying step for supplying the cleaning liquid at a second flow rate different from the first flow rate. With this construction, there is no possibility of stagnations occurring constantly inside the treating tank. Particles detaching from the substrates overflow the tank to be drained with excess parts of the cleaning liquid. The constant supply of the cleaning liquid during the cleaning treatment promotes the particle draining effect.

It is further preferred that the flow control device is arranged to repeat a cold water supplying step for supplying the cleaning liquid at room temperature, a suspending step for suspending supply of the cleaning liquid at room temperature, a warm water supplying step for supplying the cleaning liquid heated, and a suspending step for suspending supply of the cleaning liquid heated. With this construction for repeating the supply and suspension of the cleaning liquid, there is no possibility of stagnations occurring inside the treating tank. Moreover, a cleaning liquid diffusing effect produced by a temperature difference between the cold water and warm water further promotes the flows of the cleaning liquid in the tank to drain particles from the tank with increased effect.

In the above construction, the flow control device, preferably, is arranged to execute the cold water supplying step at a final stage of the cleaning treatment of the substrates. The water at room temperature supplied at the final stage of the substrate cleaning treatment prevents the substrates cleaned and raised out of the tank from being adversely influenced by the residual heat of the cleaning liquid.

Preferably, the substrate treating apparatus is arranged to store a chemical solution in the treating tank before the cleaning treatment of the substrates, and immerse the substrates in the chemical solution for chemical treatment of the substrates. This construction has an advantage of not exposing substrates with a chemical adhering thereto to ambient air, thereby improving the quality of substrate surface treatment.

The object of the invention noted hereinbefore is fulfilled also by a substrate treating method having features similar to those of the foregoing substrate treating apparatus.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a view showing principal portions of a substrate treating apparatus in a first embodiment of the invention;

FIG. 2 is a timing chart illustrating operation of the first embodiment;

FIG. 3 is a timing chart illustrating a modification;

FIG. 4 is a view showing principal portions of a substrate treating apparatus in a second embodiment; and

FIG. 5 is a timing chart illustrating operation of the second embodiment.

### DESCRIPTION OF THE PREFERRED EMBODIMENTS

Preferred embodiments of this invention will be described in detail hereinafter with reference to the drawings.

<First Embodiment>

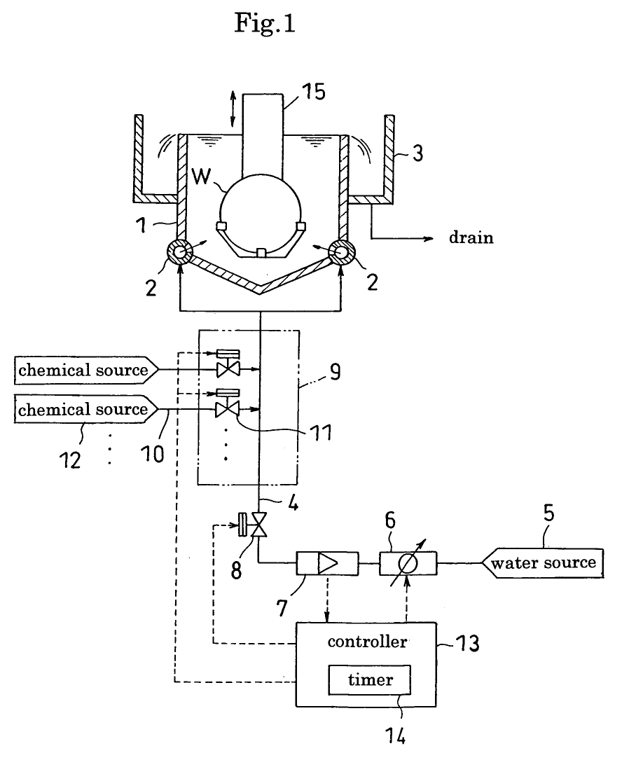

FIG. 1 is a view showing principal portions of a substrate treating apparatus in a first embodiment of the invention.

This substrate treating apparatus includes a treating tank 1 for performing chemical treatment and cleaning treatment of a plurality of wafers W placed therein. The treating tank 1 has liquid introduction pipes 2 arranged in the bottom thereof for supplying a chemical solution and a cleaning liquid into the treating tank 1. In this embodiment, deionized water is used as the cleaning liquid. An outer tank 3 is disposed around the top of the treating tank 1. An excess amount of the cleaning liquid and the like overflowing the top of the treating tank 1 are received by and drained from the outer tank 3.

The liquid introduction pipes 2 in the treating tank 1 are connected to an end of liquid feed piping 4 for supplying the chemical solution and cleaning liquid. The other end of the liquid feed piping 4 is connected to a deionized water source 5 acting as a cleaning liquid source. The liquid feed piping 4 has a pressure regulating valve 6, a flow meter 7 and a switch valve 8 arranged thereon in the stated order from the deionized water source 5.

Furthermore, a chemical introducing device 9 is disposed between the switch valve 8 and the treating tank 1. The chemicals introducing device 9 has a plurality of branch pipes 10 each connected at one end thereof to the liquid feed piping 4, and switch valves 11 mounted on the respective branch pipes 10. The other end of each branch pipe 10 is connected to a chemical source 12.

A controller 13 opens and closes the switch valves 8 and 11 based on timing given by an internal timer 14 to transmit the chemical solution and cleaning liquid to the treating tank 1 through the liquid feed piping 4 by a predetermined sequence. The controller 13 has a characteristic flow control function for causing variations with time in the feeding rate of the cleaning liquid supplied to the treating tank 1 during a cleaning treatment of wafers W loaded into the treating tank 1. The flow control is carried out by operating the pressure regulating valve 6 based on detection signals from the flow meter 7. This flow control will be described in detail hereinafter.

The liquid introduction pipes 2 and liquid feed piping 4 correspond to the cleaning liquid supply device in this invention. The pressure regulating valve 6, flow meter 7 and controller 13 correspond to the flow control device in this invention.

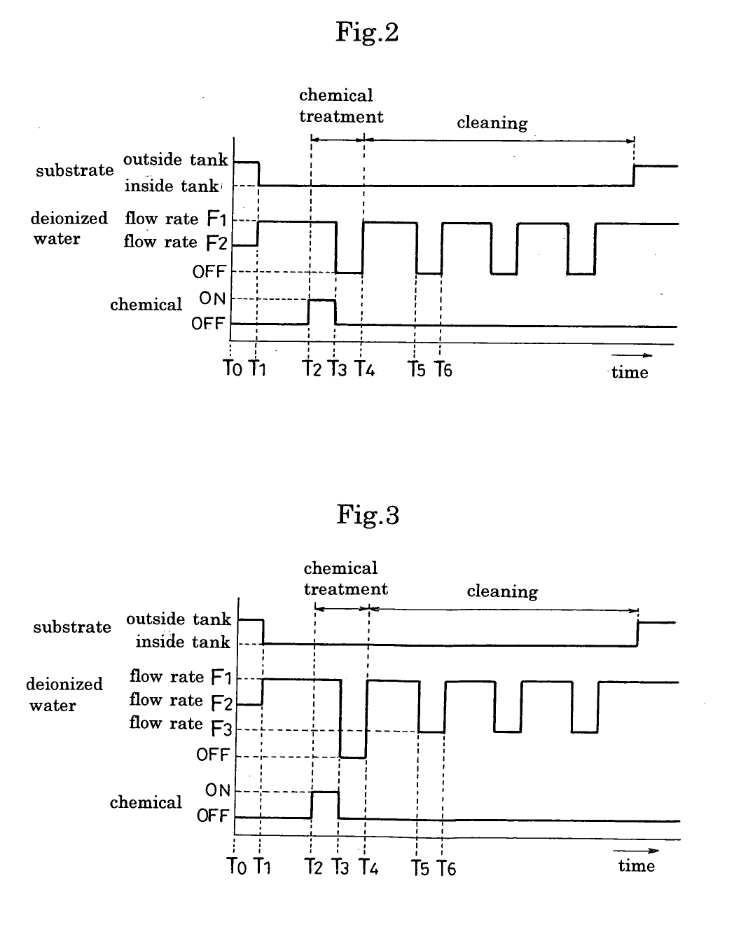

Next, operation of the apparatus in this embodiment, particularly the flow control of the cleaning liquid carried out during cleaning treatment, will be described with reference to FIG. 2. FIG. 2 shows timing of loading and unloading wafers W into/from the treating tank 1 (upper figure), timing of supplying and stopping the cleaning liquid (hereinafter “deionized water”) to the treating tank 1 (middle figure) and timing of supplying the chemical solution to the treating tank 1 (lower figure).

In an initial state (time To in FIG. 2), a plurality of wafers W to be treated are held outside the tank 1 by a lifter 15 shown in FIG. 1. At this time, the switch valve 8 on the liquid feed piping 4 is set to an open state, while each switch valve 11 of the chemical feed device 9 is set to a closed state. Consequently, only the deionized water is supplied to the treating tank 1. The feeding rate of the deionized water at this time is set to a flow rate F₂ lower than a feeding flow rate F₁ for cleaning treatment described hereinafter.

At a time T₁ in FIG. 2, the lifter 15 lowers to immerse the wafers W in the deionized water in the tank 1. At the same time, the feeding flow rate of the deionized water is increased from F₂ to F₁.

At a time T₂ in FIG. 2, a predetermined one of switch valves 11 of the chemical feed device 9 is opened to introduce a predetermined chemical into the liquid feed piping 4. The chemical introduced is mixed with the deionized water flowing through the liquid feed piping 4 to form a chemical solution of predetermined concentration to be supplied to the treating tank 1.

When the deionized water in the treating tank 1 has been replaced by the chemical solution (at a time T₃ in FIG. 2), the switch valve 8 and switch valve 11 are closed to stop the supply of the deionized water and chemical. For a predetermined time to follow, the wafers W receive chemical treatment in the treating tank 1.

After the predetermined time of chemical treatment (at a time T₄ in FIG. 2), the operation switches to a next, cleaning treatment. That is, the switch valve 8 is opened to supply deionized water at the flow rate F₁ to the treating tank 1 for a predetermined time. Then, the switch valve 8 is closed at a time T₅ in FIG. 2, to stop the supply of deionized water. After the predetermined time for suspending the supply of deionized water, the switch valve 8 is opened again at a time T₆ in FIG. 2, to supply deionized water to the treating tank 1. Subsequently, the supply and stopping of deionized water are repeated a required number of times, e.g. four to eight times.

A period of time (from T₄ to T₅ in FIG. 2) for supplying deionized water is set appropriately, which desirably is a period of time for the deionized water to replace generally the chemical solution in the treating tank 1. A period of time (from T₅ to T₆ in FIG. 2) for suspending the supply of deionized water also is set appropriately, which usually and desirably is about five to 30 seconds. A suspension for less than five seconds would not be sufficient for the cleaning liquid to subside in the treating tank 1. This would reduce the agitating effect of the cleaning liquid in the tank 1 produced by the stopping of the cleaning liquid. On the other hand, a suspension of the supply of deionized water for about 30 seconds is sufficient for the cleaning liquid to subside in the treating tank 1. A longer time of suspension would only lower cleaning efficiency, and is unlikely to improve the agitating effect of the cleaning liquid.

In this embodiment, as described above, a supplying step for supplying deionized water and a suspending step for suspending the supply of deionized water are repeated during a process of cleaning the wafers W placed in the treating tank 1. This produces variations with time in the flow of deionized water until the water introduced into the bottom of the treating tank 1 overflows the top of the treating tank 1. As a result, an agitation of the cleaning liquid is promoted inside the treating tank 1 to eliminate the possibility of stagnations occurring constantly. Particles detaching from the wafers W overflow the tank 1 to be drained with excess parts of the deionized water, instead of remaining in the tank 1. The cleaning liquid is not quickly drawn off during a substrate cleaning process as is the case with a conventional “quick drain shower type” substrate treating apparatus. The substrates are not subjected to unnecessary vibration, and thus no chance of particles resulting from vibration of the substrates.

While, in the above embodiment, deionized water is supplied for the same periods of time, the water supply time may be varied for different repetitive cycles. For example, a long supply time may be set for supplying deionized water for the first time in order to replace the chemical solution in the treating tank 1, and a shorter supply time for supplying deionized water subsequently.

In the above embodiment, the water supply step and the supply suspending step are repeated. It is also possible to repeat a first supply step for supplying deionized water at a first flow rate, and a second supply step for supplying deionized water at a second flow rate different from the first flow rate. As shown in FIG. 3, for example, deionized water may be supplied at a flow rate F₁ (e.g. 20 lit, per minute) in a first supply step (from T₄ to T₅ in FIG. 3) and at a flow rate F3 (e.g. 1 to 2 lit, per minute) in a second supply step (from T₅ to T₆ in FIG. 3). This supply mode also produces variations with time in the flow of deionized water to agitate the deionized water inside the treating tank 1. Excess parts of the deionized water overflow the treating tank 1 also in the second supply step of lower flow rate, to promote the particle draining effect.

<Second Embodiment>

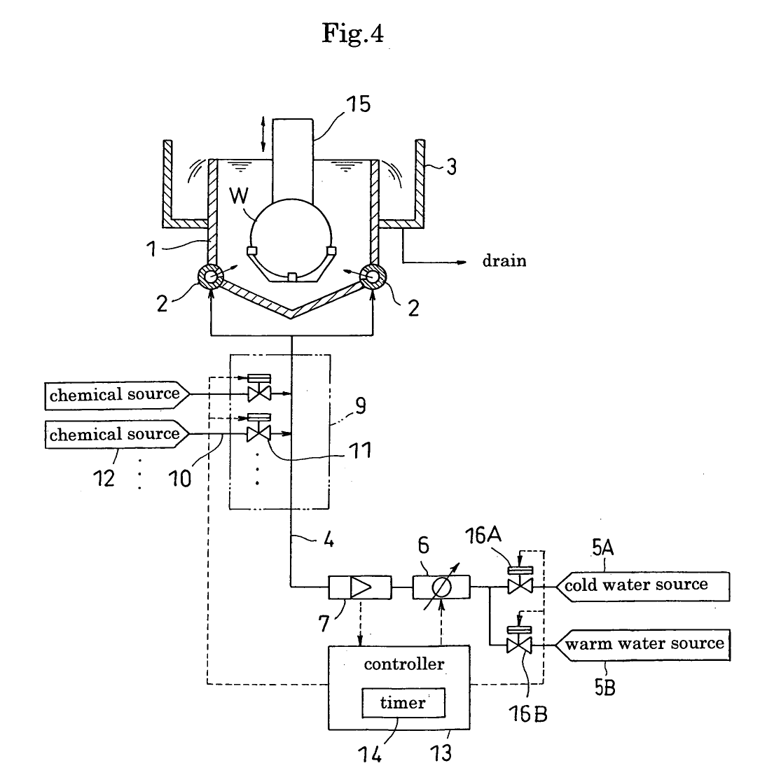

FIG. 4 is a view showing principal portions of a substrate treating apparatus in a second embodiment.

In FIG. 4, like reference numerals are used to identify like parts in FIG. 1 which are the same as in the first embodiment and will not be described again.

The apparatus in this embodiment includes a cold water source 5A connected to the liquid feed piping 4 through a switch valve 16A for supplying deionized water at room temperature (hereinafter called “cold water”), and a warm water source 5B connected to the liquid feed piping 4 through a switch valve 16B for supplying heated deionized water (hereinafter called “warm water”). This embodiment is characterized by supplying the cold water and warm water to the treating tank 1 alternately with a supply suspending step in between.

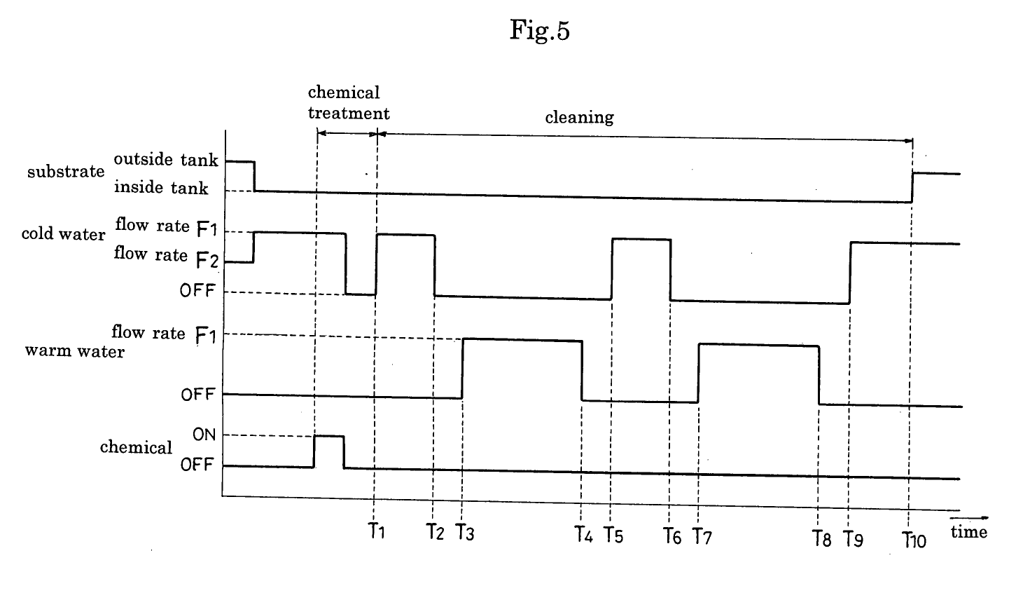

Operation of the apparatus in the second embodiment will be described hereinafter with reference to FIG. 5. The operation for chemical treatment is the same as in the first embodiment. Thus, only a cleaning operation will be described here.

First, the switch valve 16A is opened to supply cold water to the treating tank 1 to replace the chemical solution therein (from T₁ to T₂ in FIG. 5). At this time, cold water is supplied at 20 lit, per minute for 60 seconds. Then, the switch valve 16A is closed to stop the supply of cold water (T₂ in FIG. 5). Upon lapse of a predetermined time (e.g. five seconds) after stopping the cold water, the switch valve 16B is opened to supply warm water (T₃ in FIG. 5). At this time, deionized water at 65° C. is supplied at 20 lit, per minute for 125 seconds. Then, the switch valve 16B is closed to stop the supply of deionized water (T₄ in FIG. 5). After a suspension of the supply for five seconds, cold water is supplied again (T₅ in FIG. 5). The above cold water supplying step, suspending step, warm water supplying step and suspending step are repeated twice (from T₁ to T₉ in FIG. 5). After supplying deionized water at room temperature at 20 lit, per minute for 60 seconds for the last time (after a period T₉ to T₁₀ in FIG. 5), the wafers W are raised out of the treating tank 1.

In this embodiment, the repetition of supplying and suspension of cold water and warm water prevents a stagnation of flows in the tank as in the first embodiment. Thus, particles are not allowed to remain in the treating tank 1. Further, this embodiment provides a deionized water diffusing effect based on a temperature difference between the cold water and warm water, thereby further promoting the flows of the deionized water in the tank 1 to drain particles from the tank 1 with increased effect. The cold water (deionized water at room temperature) supplied at a final stage of the substrate cleaning treatment prevents the wafers W cleaned and raised out of the tank from being adversely influenced by the residual heat of the heated deionized water.

In order to verify the effect of the apparatus in the second embodiment, semiconductor wafers (substrates) with particles adhering thereto were cleaned by using the apparatus in the second embodiment and a conventional “overflow rinse type” substrate treating apparatus. Before the cleaning treatment, the semiconductor wafers had “616” areas with more than a permissible quantity of particles. The apparatus in the second embodiment reduced the particle-laden areas to “2”, while the conventional apparatus left as many as “455” such areas.

This invention is not limited to the foregoing embodiments, but may be modified as follows.

In the foregoing embodiments, the substrate treating apparatus have been described as successively performing chemical treatment and cleaning treatment in the same treating tank. Such substrate treating apparatus have an advantage of not exposing substrates with a chemical adhering thereto to ambient air, thereby improving the quality of substrate surface treatment. This invention is applicable not only to such substrate treating apparatus, but also to a substrate treating apparatus that performs only cleaning treatment separately from chemical treatment.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for performing cleaning treatment of substrates, comprising:
a treating tank for receiving a cleaning liquid introduced through a bottom thereof, and allowing an excess amount of the cleaning liquid to overflow a top thereof;
cleaning liquid supply means for supplying the cleaning liquid to said treating tank; and
flow control means for varying with time a feeding flow rate of the cleaning liquid from said cleaning liquid supply means during the cleaning treatment of the substrates placed in said treating tank.

2. A substrate treating apparatus as defined in claim 1, wherein said flow control means is arranged to repeat a supplying step for supplying the cleaning liquid, and a suspending step for suspending supply of the cleaning liquid.

3. A substrate treating apparatus as defined in claim 2, wherein the supply of the cleaning liquid is stopped for five to 30 seconds in the suspending step.

4. A substrate treating apparatus as defined in claim 2, wherein a longer time is set for supplying the cleaning liquid in the supplying step executed first than in the supplying step executed subsequently.

5. A substrate treating apparatus as defined in claim 1, wherein said flow control means is arranged to repeat a first supplying step for supplying the cleaning liquid at a first flow rate, and a second supplying step for supplying the cleaning liquid at a second flow rate different from said first flow rate.

6. A substrate treating apparatus as defined in claim 1, wherein said flow control means is arranged to repeat a cold water supplying step for supplying the cleaning liquid at room temperature, a suspending step for suspending supply of the cleaning liquid at room temperature, a warm water supplying step for supplying the cleaning liquid heated, and a suspending step for suspending supply of the cleaning liquid heated.

7. A substrate treating apparatus as defined in claim 6, wherein said flow control means is arranged to execute said cold water supplying step at a final stage of the cleaning treatment of the substrates.

8. A substrate treating apparatus as defined in claim 1, wherein said substrate treating apparatus is arranged to store a chemical solution in said treating tank before the cleaning treatment of the substrates, and immerse the substrates in said chemical solution for chemical treatment of the substrates.

9. A substrate treating method for performing cleaning treatment of substrates immersed in a cleaning liquid inside a treating tank while introducing the cleaning liquid from cleaning liquid supply means into the treating tank through a bottom thereof, and allowing an excess amount of the cleaning liquid to overflow a top of the treating tank,
wherein flow control means varies with time a feeding flow rate of the cleaning liquid from said cleaning liquid supply means during the cleaning treatment of the substrates immersed in the cleaning liquid inside said treating tank.

10. A substrate treating method as defined in claim 9, wherein said flow control means repeats a supplying step for supplying the cleaning liquid and a suspending step for suspending supply of the cleaning liquid during the cleaning treatment of the substrates immersed in the cleaning liquid inside said treating tank.

11. A substrate treating method as defined in claim 10, wherein the supply of the cleaning liquid is stopped for five to 30 seconds in the suspending step.

12. A substrate treating method as defined in claim 10, wherein a longer time is set for supplying the cleaning liquid in the supplying step executed first than in the supplying step executed subsequently.

13. A substrate treating method as defined in claim 9, wherein said flow control means repeats, during the cleaning treatment of the substrates immersed in the cleaning liquid inside said treating tank, a first supplying step for supplying the cleaning liquid at a first flow rate, and a second supplying step for supplying the cleaning liquid at a second flow rate different from said first flow rate.

14. A substrate treating method as defined in claim 9, wherein said flow control means repeats, during the cleaning treatment of the substrates immersed in the cleaning liquid inside said treating tank, a cold water supplying step for supplying the cleaning liquid at room temperature, a suspending step for suspending supply of the cleaning liquid at room temperature, a warm water supplying step for supplying the cleaning liquid heated, and a suspending step for suspending supply of the cleaning liquid heated.

15. A substrate treating method as defined in claim 14, wherein said flow control means executes said cold water supplying step at a final stage of the cleaning treatment of the substrates.

16. A substrate treating method as defined in claim 9, wherein a chemical solution is stored in said treating tank before the cleaning treatment of the substrates, and the substrates are immersed in said chemical solution for chemical treatment of the substrates.
